(19) United States
(12) Patent Application Publication
(10) Pub. No.: US 2002/0181544 A1
(43) Pub. Date: Dec. 5, 2002

(54) BI-METAL STRIP HEAT DETECTOR

(76) Inventors: Tai-Tung Huang, San Diego, CA (US); Po-Hao Huang, San Diego, CA (US)

Correspondence Address: CALIF KIP TERVO, 6387 CAMINITO LAZARO, SAN DIEGO, CA, 92111, US

(21) Appl. No.: 09/870,911

(22) Filed: Jun. 1, 2001

(51) Int. Cl. G01K 5/62; H01H 37/00; H01H 37/52

(52) U.S. Cl. 374/205; 307/117

(57) ABSTRACT

Heat detector 10 partially includes housing 20, mount 42 supported by housing 20 including an electrical contact 45, and a bi-metal strip 61 including fixed end 62 fixedly mounted to housing 20, and a free end 64 including an electrical contact 45. Bi-metal strip free end 64 moves responsive to decreasing temperature in a first direction toward mount 42 and responsive to increasing temperature in a second direction away from mount 42. Free end 64 and mount 42 are connected when free end 64 is a predetermined distance from mount 42 such that mount 42 is maintained at the predetermined distance from free end 64 as free end 64 moves in the second direction, such that contacts 45, 65 contact upon movement of free end 64 the predetermined distance in the first direction. Magnet 31 frictionally connects mount 42 to housing 20 and retains mount 42 to housing 20 regardless of orientation.

### FIELD OF THE INVENTION

This invention relates in general to bi-metal strip heat detectors, and more specifically involves a detector with faster cool-down detection time.

### BACKGROUND OF THE INVENTION

Gas burners, such as gas ranges, are subject to failures and other conditions that render them dangerous. For example, if a burner fails to light or is extinguished by an overflowing pot, continued gas flow may result in an explosion or fire or may suffocate people. Therefore, there has been a need for a safety system for a gas range that turns off the gas supply to the range upon detection of a gas leak, absence of a flame, or smoke. Such a safety system requires a heat detector that will detect the absence of a flame and will quickly detect if the flame has gone out.

### SUMMARY OF THE INVENTION

This invention is a heat detector and it partially includes a housing, a mount supported by the housing including an electrical contact mounted on the mount, and a bi-metal strip connected to the housing including a fixed end fixedly mounted to the housing, and a free end including an electrical contact mounted thereon, the free end moving responsive to decreasing temperature in a first direction toward the mount and responsive to increasing temperature in a second direction away from the mount, wherein at ambient temperature the contacts make contact. An electrical circuit connected to the first contact and the second contact detect when the contacts make contact. Connecting means connects the free end and the mount when the free end is a predetermined distance from the mount for maintaining the mount at the predetermined distance from the free end as the free end moves in the second direction, such that the strip contact contacts the mount contact upon movement of the free end the predetermined distance in the first direction.

In an exemplary embodiment a magnet cooperating between the mount and the housing frictionally connecting the mount to the housing. The magnet may retain the mount to the housing regardless of the orientation of the housing.

Other features and many attendant advantages of the invention will become more apparent upon a reading of the following detailed description together with the drawings wherein like reference numerals refer to like parts throughout.

### BRIEF DESCRIPTION OF THE DRAWINGS

FIG. 1 is a perspective view of a preferred embodiment of the heat detector of the invention.

FIG. 2 is an enlarged, partial, exploded perspective view of the moving contact mount assembly.

FIG. 3 is a side cross-section of the detector of FIG. 1 in the maximum ambient temperature position.

FIG. 4 is a side cross-section of the detector of FIG. 1 in a flame detection position.

### DETAILED DESCRIPTION OF THE INVENTION

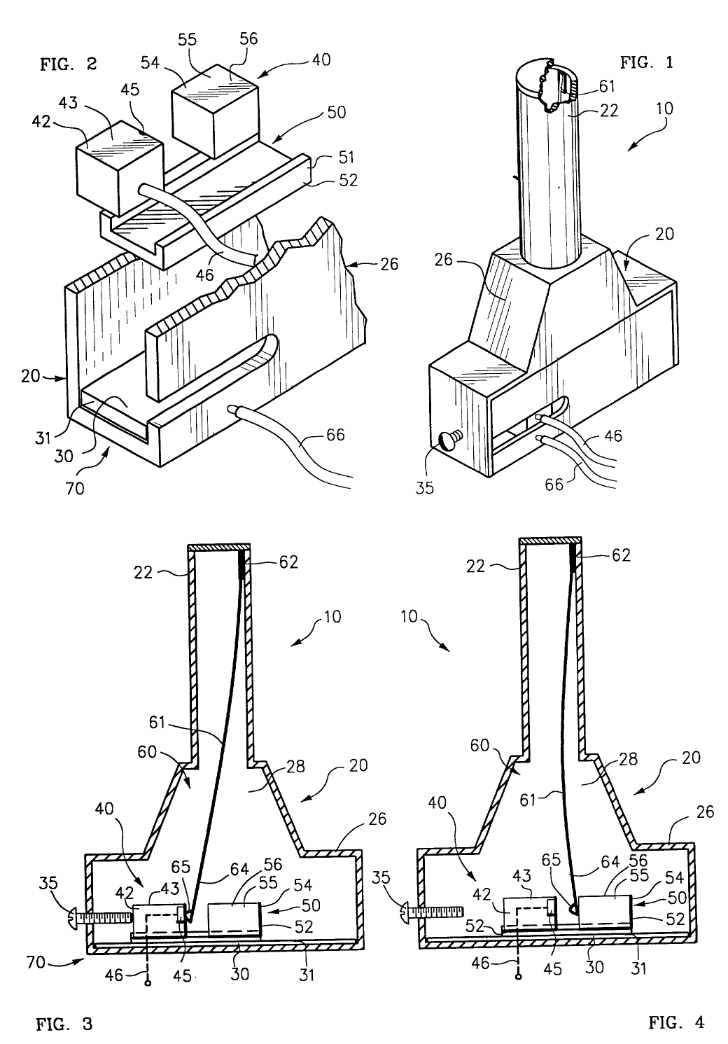

FIG. 1 is a perspective view of a preferred embodiment of the heat detector 10 of the invention. Detector 10 would commonly be used to detect the presence of a flame, such as on a cooking range, so it will be described in terms of that environment. Detector 10 could be used in a gas range safety system such as shown and described in our previous patent titled SAFETY SYSTEM FOR GAS RANGE, U.S. Pat. No. 6,164,958 which is fully incorporated herein. Detector 10 could be used as “flame detector 34” of that disclosure and could be connected to detection circuitry as shown therein or as is otherwise well-known in the art.

FIG. 2 is an enlarged, exploded, partial perspective view of a moving contact mount assembly 40. FIG. 3 is a side cross-section of the detector 10 of FIG. 1 in the maximum ambient temperature position. FIG. 4 is a side cross-section of the detector 10 of FIG. 1 in a flame detection position.

Detector 10 generally comprises a housing 20, a moving contact mount assembly 40, and a bi-metal strip assembly 60.

Housing 20 is preferably made of metal capable of withstanding exposure to high heat conditions, such as being near the flame of a cooking range. Housing 20 generally includes a heat exposure portion, such as pipe 22, and a main portion 26. Housing 20 defines an interior cavity 28. Pipe 22 is made of any suitable material, but preferrably of thin stainless steel . Pipe 22 is closely exposed or directly exposed to the heat source, such as to a flame. Preferably, housing 20 is made of electrically conducting material for conduction of a low voltage, low amperage current. Typically, housing 20 is mounted by any suitable means near a heat source, such as near to a burner on a gas range such that pipe 22 is exposed to the flame.

Bi-metal strip assembly 60 includes a bi-metal strip 61 mounted in interior 28 of housing 20 and including a fixed end 62 fixedly mounted to pipe 22, and a free end 64. Free end 64 moves responsive to temperature changes between the ambient temperature configuration of FIG. 3 and a high temperature configuration of FIG. 4. This movement will be more fully explained later. An electrical contact 65 is mounted on free end 64. Electric wire 66 is in electrical contact with contact 65. In the embodiment shown, housing 20 and bi-metal strip 61 are conductive such that wire 66 need only be attached to housing 20 to make contact with strip contact 65. Bi-metal strip 61 is very stable in character and reliable in repeat movement.

Moving contact mount assembly 40 is mounted in interior space 28 of housing 20 and generally comprises a mount 42, a mount electrical contact 45, and connecting means 50. Mount 42, such as an insulating block, such as phenolic block 43, has electrical contact 45 mounted thereon. Insulated wire 46 is electrically connected to contact 45. Connecting means 50 connects free end 64 and mount 42 when free end 64 is a predetermined distance from mount 42 such that mount 42 is maintained at the predetermined distance from free end 64 as free end 64 moves in the second direction. Thus, strip contact 65 contacts mount contact 45 upon movement of free end 64 the predetermined distance in the first direction. If free end 64 did not move mount 42 along with it as temperature increased, then, upon decreasing temperature, bi-metal strip 61 free end 64 would have cool all the way to high ambient temperature as shown in FIG. 1 to make contact and indicate a no-flame situation. This is too long a period to have gas venting into a room should a flame be accidently extinguished for any reason with the gas still on. The predetermined distance determines the decrease in temperature that will be detected. In the preferred embodiment shown, connecting means 50 comprises a sheet 51 and a catch 54. Sheet 51 is of ferrous material so as to be attracted to a magnet and may be made of steel or iron. Mount 42 is attached by any suitable means to sheet 51. Catch 54, such as insulated block 55, such as phenolic block 56, is attached to ferrous sheet 52 a predetermined distance from mount 42 such that free end 64 of bi-metal strip 61 is disposed between mount 42 and catch 54.

Other connecting means are contemplated. For example, a flexible tension member of the predetermined length can connect mount 42 and free end 64. The flexible tension member could be a thin wire or cord connected to phenolic block 43. Also, a hook or loop could extend from block 43 and serve as catch 54. These methods eliminate catch block 56.

Mount 42 is supported by housing 20 and is frictionally attached in that mount 42 will not move unless moved by connecting means 50 or set screw 35. In the embodiment shown, mount 42 is attached to ferrous sheet 52. Housing 20 and mount 42 include cooperating means for allowing mount 42 to move relative to housing 20 and yet be held to housing 20. To this end, housing 20 includes an inner surface 30 comprising a weak magnet 31, such as a rubberized or ceramic magnet, that holds sheet 52 to housing 20 such that sheet 52 can slide along surface 30 under a weak force but is otherwise held in place in housing 20 regardless of the orientation of housing 20 and inner surface 30.

Wires 46, 66 are part of an electrical circuit of a type well-known in the art for detecting when contacts 45, 65 make contact, thereby indicating there is no heat or flame, and when they do not, thereby indicating that there is a flame.

The functioning of these components is best understood in reference to FIGS. 3 and 4. Free end 64 moves responsive to decreasing temperature in a first direction toward mount 42 and responsive to increasing temperature in a second direction away from mount 42. FIG. 3 shows the location of mount 42 and free end 64 at ambient temperature. Mount contact 45 and strip contact 65 are touching. Adjustment screw 35 is threadably attached to housing 20 and bears against mount 42. Adjustment screw 35 is initially adjusted so as to adjust the maximum position of mount 42 in the first direction such that strip contact 65 will remain in contact with mount contact 45 over the ambient temperature range. As screw 35 is screwed in, mount 42 is slid in the second direction. This prevents common fluctuations in ambient temperature from opening the circuit and indicating there is heat or a flame present when there is none.

When a flame is present such that bi-metal strip 61 is heated, free end 64 moves in the second direction, i.e. away from mount 42. After moving the predetermined distance in the second direction, free end 64 encounters catch 54. After this point, further movement in the second direction by free end 64 slides moving contact mount assembly 40, including catch 54 and mount 42, along with it in the second direction. In this manner the gap between strip contact 65 and mount contact 45 is never more than the predetermined distance. During this period, contacts 45, 65 are not in contact so the detector circuit indicates that there is a flame. Should the flame be extinguished, such as by a pot boiling over, the return of temperature to ambient will cause free end 64 to move in the first direction. It only needs to move the predetermined distance to make contact. If contact is made between contacts 45, 65, the circuit will interpret it as a no-flame situation. If cooling continues, free end 64 will move further in the first direction and slide mount 42 in front of it until mount is stopped by adjustment screw 35. In this position, moving contact mount assembly 40 is reset and responsive to relighting of the flame.

Responsive to a no-flame signal, the attached circuit may be used for shutting off the gas supply, for turning on a fan, for sounding an alarm, or any other desired function.

Although the invention is described primarily in terms of a flame detector for a gas range, this invention is not so restricted and may be applied to other fields such as water heaters.

Although a particular embodiment of the invention has been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

We claim:

1. A heat detector comprising:
a housing;
a mount supported by said housing including;
an electrical contact;
a bi-metal strip connected to said housing including:
a fixed end fixedly mounted to said housing; and
a free end including:
a electrical contact; said free end moving responsive to decreasing temperature in a first direction toward said mount and responsive to increasing temperature in a second direction away from said mount, wherein at ambient temperature said contacts make contact;
electrical circuit means connected to said first contact and said second contact for detecting when said contacts make contact; and
connecting means connecting said free end and said mount when said free end is a predetermined distance from said mount for maintaining said mount at the predetermined distance from said free end as said free end moves in the second direction, such that said strip contact contacts said mount contact upon movement of said free end the predetermined distance in the first direction.

2. A heat detector comprising:
a housing;
a mount supported by said housing including;
an electrical contact;
a magnet frictionally connecting said mount to said housing;
a bi-metal strip connected to said housing including:
a fixed end fixedly mounted to said housing; and
a free end including:
an electrical contact; said free end moving responsive to decreasing temperature in a first direction toward said mount and responsive to increasing temperature in a second direction away from said mount, wherein at ambient temperature said contacts make contact;
electrical circuit means connected to said first contact and said second contact for detecting when said contacts make contact; and
connecting means connecting said free end and said mount when said free end is a predetermined distance from said mount for maintaining said mount at the predetermined distance from said free end as said free end moves in the second direction, such that said strip contact contacts said mount contact upon movement of said free end the predetermined distance in the first direction.

3. The heat detector of claim 2 wherein:
said magnet retains said mount to said housing regardless of the orientation of said housing.
